(19) United States
(12) Patent Application Publication
(10) Pub. No.: US 2009/0122019 A1
(43) Pub. Date: May 14, 2009

(54) Display For Information Handling System

(75) Inventors: Der Chyuan Lin, Kaohsiung (TW); Shu Hao Hsu, Taipei City (TW); Ying-Ying Lu, Jhonghe City (TW)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 11/938,587

(22) Filed: Nov. 12, 2007

(51) Int. Cl. G06F 1/16; G06F 3/041

(52) U.S. Cl. 345/173; 345/173

(57) ABSTRACT

An information handling system includes a chassis. A first display is coupled to the chassis. A card slot is defined by the chassis. A window is defined by the chassis immediately adjacent the card slot, and a card including a second display may be positioned in the card slot such that the second display may be viewed through the window.

### BACKGROUND

The present disclosure relates generally to information handling systems, and more particularly to a display for an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

It is sometimes desirable to provide a plurality of displays for an IHS in order to, for example, dedicate one display to a particular application and use the other display for other applications. The provision of a plurality of displays for an IHS raises a number of issues.

Conventionally, a plurality of displays may be provided for a desktop IHS and is only limited by the amount of space the user has to hold the displays. However, providing a plurality of displays on a portable IHS is limited by the desire to minimize the size and weight of the portable IHS in order to enhance its portability.

Accordingly, it would be desirable to provide an improved IHS with a plurality of displays.

### SUMMARY

According to one embodiment, an IHS includes a chassis, a first display coupled to the chassis, a card slot defined by the chassis, and a window defined by the chassis immediately adjacent the card slot, wherein a card comprising a second display may be positioned in the card slot such that the second display may be viewed through the window.

### BRIEF DESCRIPTION OF THE DRAWINGS

FIG. 1 is a schematic view illustrating an embodiment of an IHS.

FIG. 2 is a perspective view illustrating an embodiment of a card.

FIG. 3a is a perspective view illustrating an embodiment of an IHS used with the card of FIG. 2.

FIG. 3b is a cross sectional view illustrating an embodiment of the IHS of FIG. 3a.

FIG. 4a is a flow chart of a method for providing a plurality of displays on an IHS.

FIG. 4b is a perspective view illustrating an embodiment of the card of FIG. 2 being positioned in the IHS of FIGS. 3a and 3b.

FIG. 4c is a perspective view illustrating an embodiment of the card of FIG. 2 positioned in the IHS of FIGS. 3a and 3b.

FIG. 4d is a cross sectional view illustrating an embodiment of the card of FIG. 2 positioned in the IHS of FIGS. 3a and 3b.

FIG. 4e is a perspective view illustrating an embodiment of the card of FIG. 2 positioned in the IHS of FIGS. 3a and 3b and displaying information.

FIG. 4f is a perspective view illustrating an embodiment of the IHS of FIGS. 3a and 3b with a transparent material positioned in the window.

FIG. 4g is a perspective view illustrating an embodiment of the IHS of FIGS. 3a and 3b with an opaque material positioned in the window.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

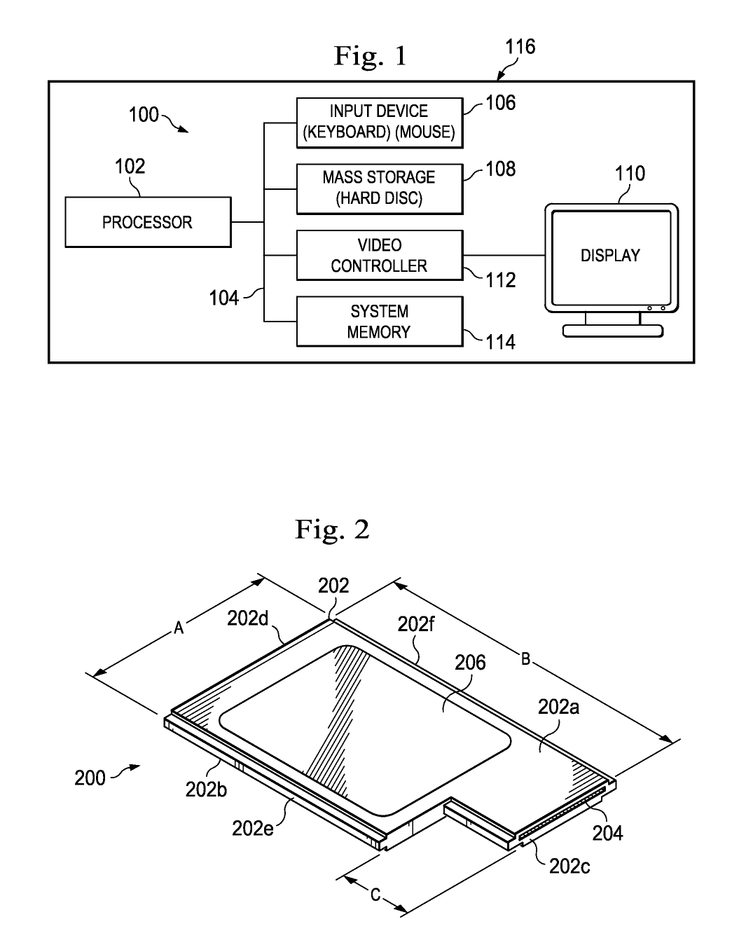

In one embodiment, IHS 100, FIG. 1, includes a processor 102, which is connected to a bus 104. Bus 104 serves as a connection between processor 102 and other components of computer system 100. An input device 106 is coupled to processor 102 to provide input to processor 102. Examples of input devices include keyboards, touchscreens, and pointing devices such as mouses, trackballs and trackpads. Programs and data are stored on a mass storage device 108, which is coupled to processor 102. Mass storage devices include such devices as hard disks, optical disks, magneto-optical drives, floppy drives and the like. IHS 100 further includes a display 110, which is coupled to processor 102 by a video controller 112. A system memory 114 is coupled to processor 102 to provide the processor with fast storage to facilitate execution of computer programs by processor 102. In an embodiment, a chassis 116 houses some or all of the components of IHS 100. It should be understood that other buses and intermediate circuits can be deployed between the components described above and processor 102 to facilitate interconnection between the components and the processor 102.

Referring now to FIG. 2, a card 200 is illustrated. In an embodiment, the card 200 may be an ExpressCard (as illustrated), a PCI card, a mini PCI card, and/or a variety of other cards known in the art. In an embodiment, the card 200 is a 54 millimeter ExpressCard. The card 200 includes a base 202 having a top surface 202a, a bottom surface 202b located opposite the top surface 202a, a front surface 202c extending between the top surface 202a and the bottom surface 202b, a rear surface 202d located opposite the front surface 202c and extending between the top surface 202a and the bottom surface 202b, and a pair of opposing side surfaces 202e and 202f extending between the top surface 202a, the bottom surface 202b, and the rear surface 202d. A connector 204 is located on the front surface 202c of the card 200. A display 206 is located on the top surface 202a of the card 200. In an embodiment, the display 206 may be, for example, a slim Light Emitting Device (LED) backlit display and/or a variety of other displays known in the art. In an embodiment, the display 206 includes touch screen functionality that allows a user of the display to provide input to an IHS connected to the display 206 by touching the surface of the display 206. In the illustrated embodiment, the card 200 has a first dimension A, measured between the pair of opposing side surfaces 202e and 202f. In an embodiment, the first dimension A is approximately 54 mm. In the illustrated embodiment, the card 200 has a second dimension B, measured between the front surface 202c and the rear surface 202d. In an embodiment, the second dimension B is approximately 75 mm. In the illustrated embodiment, the card 200 has a third dimension C, measured between the front surface 202c and an end of the side surface 202e. In an embodiment, the third dimension C is approximately 22 mm.

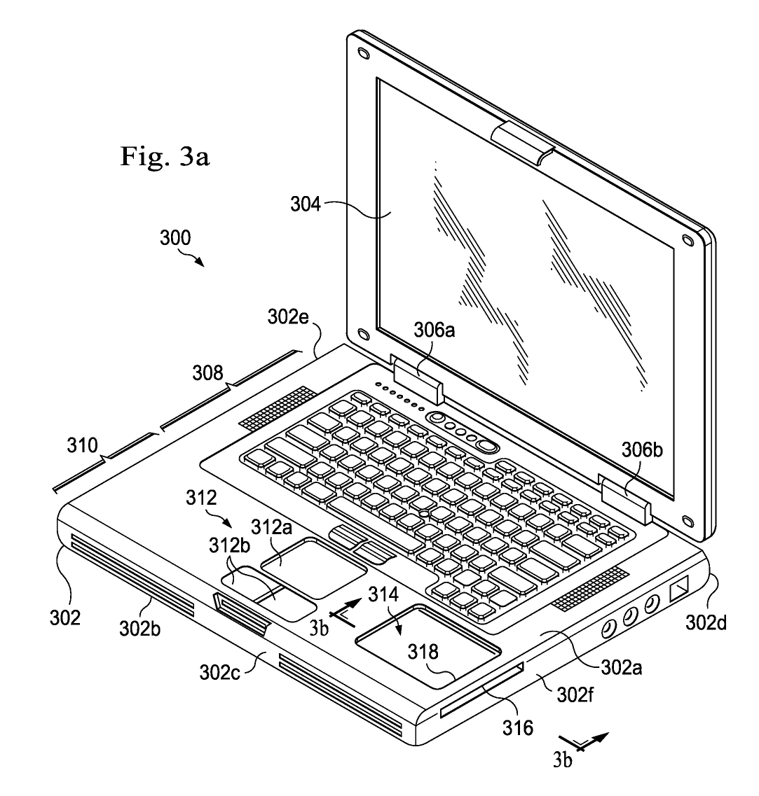

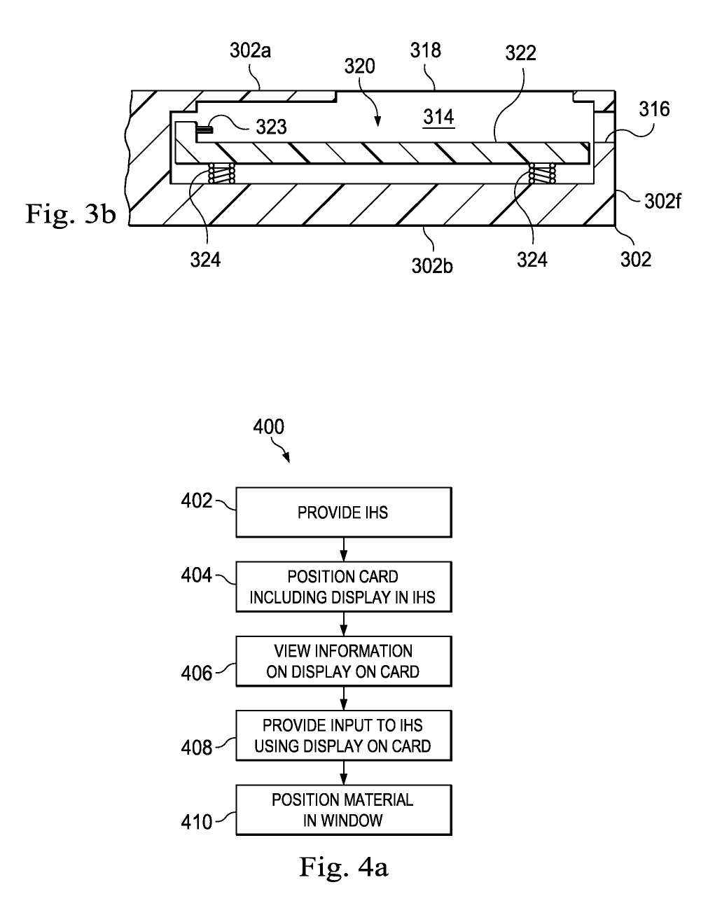

Referring now to FIGS. 3a and 3b, an IHS 300 is illustrated. In an embodiment, the IHS 300 may be, for example, the IHS 100, described above with reference to FIG. 1. The IHS 300 includes a chassis 302 having a top surface 302a, a bottom surface 302b located opposite the top surface 302a, a front surface 302c extending between the top surface 302a and the bottom surface 302b, a rear surface 302d located opposite the front surface 302c and extending between the top surface 302a and the bottom surface 302b, and a pair of opposing side surfaces 302e and 302f extending between the top surface 302a, the bottom surface 302b, the front surface 302c, and the rear surface 302d. In an embodiment, the chassis 302 may be the chassis 116, described above with reference to FIG. 1. A display 304 is pivotally coupled to the chassis 302 by a pair of hinges 306a and 306b. In an embodiment, the display 304 may be, for example the display 110, described above with reference to FIG. 1. A first input device 308 is located on the top surface 202a of the chassis 302 and adjacent the display 304. In an embodiment, the first input device 308 is a keyboard. A palm rest section 310 is located on the top surface 302a of the chassis 302 and between the first input device 308, the front surface 302c and the pair of side surfaces 302e and 302f. A second input device 312 is centrally located in the palm rest section 310 and, in an embodiment, includes a touch pad 312a and a plurality of buttons 312b. A card slot 314 and a card slot entrance 316 are defined by the chassis 302, with the card slot entrance 316 located on the side surface 302f and providing access to the card slot 314. In an embodiment, the card slot 314 includes dimensions such that it may house a 54 millimeter ExpressCard and couple that ExpressCard to the IHS 300. A window 318 is defined by the chassis 302 and located immediately adjacent the card slot 314. In an embodiment, a card moving system 320 is located in the card slot 314 and includes a card support 322, a connector 323 extending from the card support 322, and a plurality of support movers 324 coupling the card support 322 to the chassis 302. In an embodiment, the connector 323 is coupled to a processor such as, for example, the processor 102, described above with reference to FIG. 1.

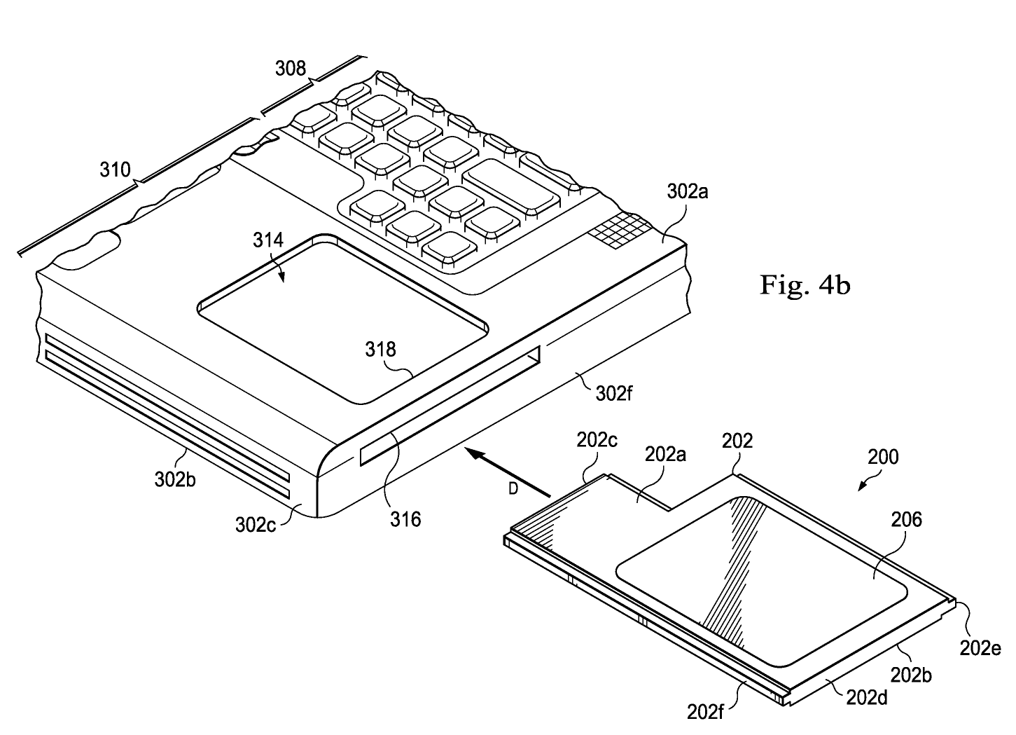

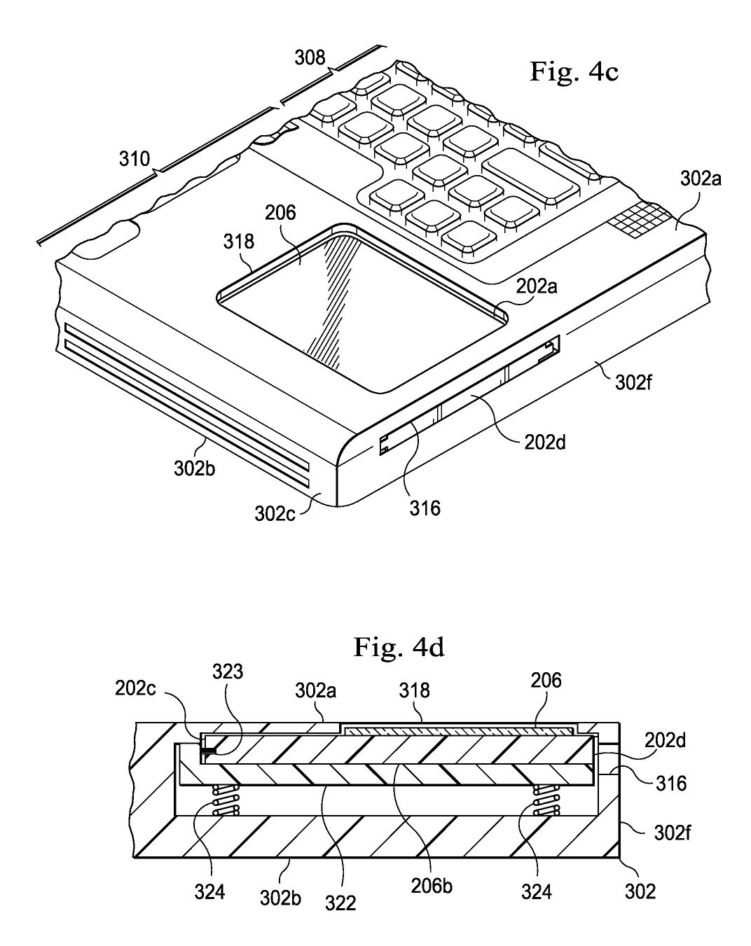

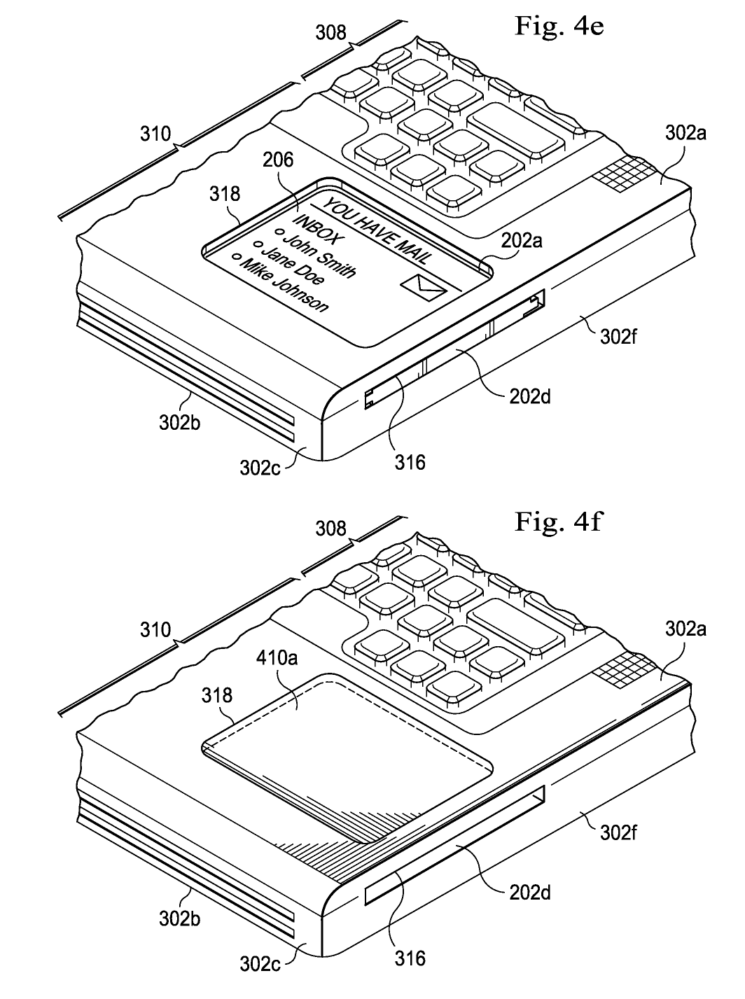

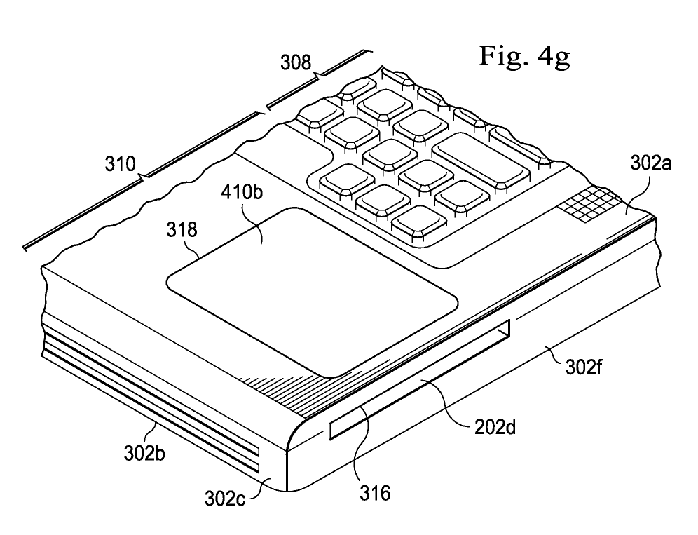

Referring now to FIGS. 1, 2, 3a, 3b, 4a, 4b and 4c, a method 400 for providing a plurality of displays on an IHS is illustrated. The method 400 begins at block 402 where an IHS such as, for example, the IHS 100 and/or the IHS 300 are provided. In an embodiment, the processor 102 may enable the provision of data to a display such as, for example, to the display 110 on the IHS 100 or to the display 304 on the IHS 300, and that data may be used to create images on the display for a user of the IHS 300 to view. In addition to enabling the provision of data to the display, the processor 102 may also enable the monitoring of the card slot 314 for the presence of a card by, for example, monitoring the connector 312 to determine if the connector 312 is engaging a card and/or using a variety of other monitoring methods known in the art. The method 400 then proceeds to block 404 where the card 200 is positioned in the IHS 300. The card 200 is positioned adjacent the IHS 300 such that the front surface 202c of the card 200 is located adjacent the card slot entrance 316 on the IHS 300, as illustrated in FIG. 4b. The card 200 is then moved in a direction D such that the card 200 enters the card slot 314 through the card slot entrance 316. The card 200 is moved through the card slot 314 until the connector 204 on the card 200 engages the connector 323 located in the card slot 314. In response to the connectors 204 and 322 engaging, the processor 102 may enable the detection of the card 200 in the IHS 300. In an embodiment, the detection of the card 200 in the IHS 300 includes recognition by the IHS 300 that the card 300 includes the display 206. With the card 200 positioned in the card slot 314, the display 206 on the card 200 is located immediately adjacent the window 318 defined by the chassis 302 of the IHS 300, as illustrated in FIG. 4c. In an embodiment, upon the engagement of the connectors 204 and 322 on the card 200 and the IHS 300, respectively, the support movers 324 are actuated to move the card support 322 towards the window 318 such that the display 206 on the card 200 is located substantially in the window 318, as illustrated in FIG. 4d. In an embodiment, a release mechanism (not illustrated) may be provided to move the card support 322 away from the window 318 so that the card 200 may be removed from the card slot 314.

Referring now to FIGS. 1, 2, 3a, 3b, 4a and 4e, the method 400 then proceeds to block 406 where information is viewed on the display 206 of the card 200. The processor 102 may enable the provision of data to the display 206 of the card 200 to allow a user of the IHS 300 to view images on the display 206. In an embodiment, the processor 102 may enable the provision of electronic mail information to the display 206 such that the display 206 allows a user to view electronic mail information including, for example, an indication that electronic mail has been received and whom the electronic mail has been received from, illustrated in FIG. 4e. In an embodiment, the processor 102 may enable the provision of system information to the display 206 such that the display 206 allows a user to view system information including, for example, an battery capacity, processor utilization, network connection details, and/or a variety of other system information known in the art. While examples have been provided of the type of information provided to and displayed by the display 206, such examples should not be limiting, as the display 206 may display any type of information. The method 400 then proceeds to block 408 where input is provided to the IHS using the display 206 on the card 200. In an embodiment, the display 206 includes a touch sensitive screen, as described above, and the user may touch the display 206 to, for example, select an electronic message, illustrated in FIG. 4e, to view the selected electronic message. In response to the user selecting an electronic message to view, the processor 102 may enable the receiving of the touch input and the provision of the electronic message data to the display 206 to allow the user to view the selected electronic message.

Referring now to FIGS. 1, 2, 3a, 3b, 4a, 4f and 4g, the method 400 may then proceed to block 410 where a material is positioned in the window 314 defined by the IHS 300. In an embodiment, block 410 of the method 400 may occur at any point in the method 400 such as, for example, before, during, or after the card 200 has been positioned in the IHS 300. In an embodiment, the user, and IHS supplier or manufacturer, and/or a variety of other entities known in the art, may position a transparent material 410a in the window 314, as illustrated in FIG. 4f. In an embodiment, the transparent material may include a clear plastic, a glass, a lens, and/or a variety of other transparent materials known in the art. With the transparent material positioned in the window 314, the display 206 on the card 200 is viewable while protecting the display 206, the card 200, and other devices located in the card slot 314 in the IHS 300. In an embodiment, with either no material positioned in the window 314 or the transparent material 410 positioned in the window 314, the user may easily determine whether a card is positioned in the card slot 314 and/or what type of card is positioned in the card slot 314. In an alternative embodiment, the user may position an opaque material 410b in the window 314, as illustrated in FIG. 4g. With the opaque material 410b positioned in the window 314, a card located in the card slot 314 is not viewable. In an embodiment, the user may have a card without a display in addition to the card 200 with the display 206. The user may remove the card 200 from the IHS 300 and position a card that does not include a display in the card slot 314 when the user does not need use of the display 206 on the card 200. While the IHS 300 has been illustrated as a portable IHS, the disclosure is not so limited, and other IHSs such as, for example, servers, desktop IHS, and a variety of other IHSs known in the art, are within its scope. Thus, a system and method have been described that provide a plurality of displays on an IHS. In an embodiment, the system and method use systems already provided on the IHS such that the size and weight of the IHS is not greatly effected by the provision of the plurality of displays.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. An information handling system, comprising:
a chassis;
a first display coupled to the chassis;
a card slot defined by the chassis; and
a window defined by the chassis immediately adjacent the card slot, wherein a card comprising a second display may be positioned in the card slot such that the second display may be viewed through the window.

2. The system of claim 1, wherein the chassis comprises a plurality of input devices and a palm rest section, wherein the window is located in the palm rest section.

3. The system of claim 1, further comprising:
a substantially transparent material located in the window.

4. The system of claim 1, further comprising:
a card moving system that is operable to move the second display on the card towards the window when the card is positioned in the card slot.

5. The system of claim 1, wherein the first display is pivotally coupled to the chassis.

6. The system of claim 1, wherein the card slot comprises dimensions suitable to accept a 54 millimeter ExpressCard.

7. The system of claim 1, further comprising:
a card comprising a second display located in the card slot adjacent the window.

8. The system of claim 7, wherein the second display comprises a touch sensitive display.

9. The system of claim 7, wherein the card comprises a 54 millimeter ExpressCard.

10. The system of claim 1, further comprising:
a processor located in the chassis, wherein the positioning of the card in the card slot couples the card to the processor.

11. A method for providing a plurality of displays on an information handling system, comprising:
providing an information handling system comprising a chassis, a first display coupled to the chassis, a card slot defined by a chassis, and a window defined by the chassis immediately adjacent the card slot; and
positioning a first card comprising a second display in the card slot, wherein the second display is viewable through the window.

12. The method of claim 11, wherein the positioning the first card comprising the second display in the card slot comprises a card moving system moving the second display on the first card towards the window.

13. The method of claim 11, further comprising:
touching the second display to provide input to the information handling system.

14. The method of claim 11, further comprising:
removing the first card from the card slot and positioning a second card in the card slot.

15. The method of claim 11, further comprising:
positioning a transparent material in the window.

16. The method of claim 11, further comprising:
positioning an opaque material in the window.

17. A method for providing a plurality of displays on an information handling system, comprising:
providing data to a first display;
monitoring a card slot for the presence of a card;
detecting a card comprising a second display in the card slot; and
providing data to the second display.

18. The method of claim 17, wherein the providing data to the second display comprises providing system information to the second display.

19. The method of claim 17, wherein the providing data to the second display comprises providing electronic mail information to the second display.

20. The method of claim 17, further comprising:
receiving a touch input from the second display.

21. An information handling system (IHS) comprising:
a chassis having a top and a base, the top being movable between an open position exposing the base and a closed position covering the base;
a first display mounted in the top and being viewable in response to the top being in the open position;
a keyboard mounted on the base; and
a second display removably mounted in the base adjacent the keyboard and being viewable simultaneously with the first display.

22. The IHS of claim 21 further comprising:
a card slot in the base; and
a card including the second display being insertable into the card slot.

23. The IHS of claim 22 further comprising:
a window in he base; and
the second display being viewable through the window.
